(19) United States
(12) Patent Application Publication
(10) Pub. No.: US 2007/0237058 A1
(43) Pub. Date: Oct. 11, 2007

(54) Recording and reproducing apparatus, recording and reproducing method, and method of determining type of recording medium

(76) Inventors: Yun Sup Shin, Seongnam-si (KR); Jeong Kyo Seo, Anyang-si (KR)

Correspondence Address: HARNESS, DICKEY & PIERCE, P.L.C., P.O. BOX 8910, RESTON, VA, 20195, US

(21) Appl. No.: 11/727,419

(22) Filed: Mar. 26, 2007

(30) Foreign Application Priority Data
Apr. 11, 2006 (KR) 10-2006-0032802
Jul. 13, 2006 (KR) 10-2006-0065740

(51) Int. Cl. G11B 7/00

(52) U.S. Cl. 369/112.24; 369/44.23

(57) ABSTRACT

A method of effectively determining a recording medium, a recording and reproducing method using the same, and a recording and reproducing apparatus using the same are disclosed. Since a narrow distance between a lens and the recording medium must be maintained in the recording and reproducing using a near field, the recording and reproducing apparatus further includes a focus adjuster to adjust a position where a light beam is focused. When a variation of a signal generated during the scanning of focuses is detected by adjusting the focus adjuster, it is possible to determine the recording medium.

This application claims the benefit of Korean Patent Application Nos. 10-2006-0032802, filed on Apr. 11, 2006 and 10-2006-0065740, filed on Jul. 13, 2006, which are hereby incorporated by reference as if fully set forth herein.

### BACKGROUND OF THE INVENTION

1. Field of the Invention

The present invention relates to a recording and reproducing apparatus, a recording and reproducing method, and a method of determining a type of a recording medium, and more particularly, to a method of effectively determining a type of a recording medium, a recording and reproducing method using the same, and a recording and reproducing apparatus using the same.

2. Discussion of the Related Art

Generally, an optical recording and reproducing apparatus is an apparatus to record data in a recording medium such as a compact disc (CD), a digital versatile disc (DVD), and the like and to reproduce the data recorded in the recording medium. As it is required to process a high-density motion picture in order to satisfy a user's increasing demands and a motion picture compressing technique is developing, a high-density recording medium is required. One of essential techniques necessary to develop the high-density recording medium is a technique in relation to an optical head, namely, an optical pick-up.

In the above recording medium, recording density may be dependent on a diameter of a light beam projected on a recording layer of the recording medium. In other words, the smaller the diameter of the light beam to be projected and focused on the recording medium is, the more the recording density is increased. In this case, the diameter of the focused light beam is mainly determined by two factors. One is a numeric aperture (NA), that is, the performance of a lens used in focusing the light beam, and the other is a wavelength of the light beam focused on the lens.

Since the recording density is increased as the wavelength of the focused light beam is reduced, a light beam with a short wavelength is used as a solution of increasing the recording density. In other words, in comparison to a case of using a red light beam, in a case of using a blue light beam, the higher recording density can be obtained. However, in a case of a far field recording head using a conventional lens, since diffraction of the light beam has a limit, there is also a limit to decrease the diameter of the light beam. In order to solve the problem, it is a recent trend to develop a near field recording (NFR) apparatus using near field optics to enable to store and read information in a unit shorter than the wavelength of the light beam.

The NFR apparatus using a lens obtains a light beam with a limit under the diffraction limit by using a lens with a refractive index higher than an objective lens, and the light beam is propagated in the form of an evanescent wave to a recording medium close to an interface resulting in storing high-density bit information. FIG. 1 is a schematic view partially illustrating a lens to project a light beam on the recording medium and the recording medium in the NFR apparatus. As illustrated, a lens unit of the NFR apparatus may be configured such that a light beam focused by an objective lens 111 passes through a high-index lens 112. In this case, the light beam, entering the high-index lens 112 at an angle equal to or greater than a critical angle, is totally reflected during the emission from the high-index lens 112 and forms a light beam with a weak intensity on the surface of the lens. In other words, the evanescent wave is formed. The evanescent wave enables a high resolution otherwise impossible to implement because of the diffraction limit of wavelength in an apparatus using a single lens. At that time, the high-index lens 112 and the recording medium 113 approach each other very closely to within a short distance of 100 nm to generate a near field so that the high-density bit information caused by the evanescent wave can be stored. Here, a region to generate the evanescent wave as described above is known as the near field for the convenience of illustration.

However, the conventional art has disadvantages as follows.

Since, in order to maintain the evanescent wave, the lens must maintain the short distance from the recording medium, thus it is difficult to move the objective lens itself to change a focusing position.

Moreover, since structural information of the recording medium is obtained from managing information stored in the recording medium, it takes a considerable time for determining whether a recording medium is a desired recording medium or not.

### SUMMARY OF THE INVENTION

Accordingly, the present invention is directed to a recording and/or reproducing apparatus, recording method and method of determining type of recording medium substantially obviates one or more problems due to limitations and disadvantages of the related art.

An object of the present invention is to provide a recording and reproducing apparatus in which a focusing position where a light beam is projected on a recording medium varies and a method of varying the focusing position.

Another object of the present invention is to provide a method of effectively determining structure of a recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein an optical pick-up including: a lens unit to focus or project a light beam emitted from a light source; a focus adjuster, provided in a path of the light beam, to vary a position where the light beam is projected on a recording medium and to scan the recording medium; and an photo-detecting unit to receive the light beam reflected by the recording medium and to generate a signal. Here, the focus adjuster includes at least one adjustable lens to vary the path of the light beam.

In another aspect of the present invention, a recording and reproducing apparatus including: a lens unit to focus or project a light beam emitted from a light source; a focus adjuster, provided in a path of the light beam, to vary a position where the light beam is projected on a recording medium and to scan the recording medium; an photo-detecting unit to receive the light beam reflected by the recording medium and to generate a signal; and a controller to determine the recording medium using the signal generated during the scanning. Here, the controller generates information about a number, a thickness, and a position of recording layers of the recording medium in response to a period of the varying signal. For example, the controller determines a position where the light beam is focused when a value of a focus error signal becomes 0 (zero), as a position of a recording layer, or a position where the light beam is focused when a value of a radio frequency signal or a tracking error signal is maximal, as a position of a recording layer.

In another aspect of the present invention, a recording and reproducing apparatus including: a lens unit including an objective lens and a high-index lens having a refractive index higher than that of the objective lens; a focus adjuster, provided in a path of a light beam emitted from a light source and projected on a recording medium, to vary a position where the light beam is projected on the recording medium and to scan the recording medium; first and second photo-detectors to respectively receive light beams reflected by the recording medium and split by a splitting and combining unit; and a controller to determine the recording medium using a signal generated during the scanning. Here, the first photo-detector generates a gap error signal and the second photo-detector generates a focus error signal, a tracking error signal, or a radio frequency signal.

In another aspect of the present invention, a method of determining a recording medium in a recording and reproducing apparatus, the method including: (a) minutely controlling a position of a light beam being focused on the recording medium; (b) controlling the position of the light beam being projected on the recording medium in a scale greater than the step (a); and (c) scanning focuses on the recording medium and determining the recording medium, using the controlling in the step (b).

Here, in the step (a), a feedback control of a distance between a lens unit of the recording and reproducing apparatus and the recording medium is carried out to prevent the light beam from deviating from a recording layer of the recording medium during a recording and reproducing process, and in the step (b), a position where the light beam is focused on the recording medium is varied by adjusting a focus adjuster of the recording and reproducing apparatus. Moreover, in the step (c), a number, a thickness, or a position of a recording layer of the recording medium is determined in response to a periodic property of a varying signal detected during the scanning of the focuses.

In another aspect of the present invention, a recording medium determining method of a recording and reproducing apparatus comprising a lens unit and a focus adjuster, provided in a path of a light beam entering the lens unit, to vary a position where the light beam is focused on a recording medium, the method including: adjusting the focus adjuster when the recording medium is inserted into the recording and reproducing apparatus; and determining the recording medium by scanning the recording medium.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings;

FIG. 1 is a schematic sectional view partially illustrating an optical pick-up of a conventional optical recording apparatus using a near field;

FIG. 2 is a block diagram illustrating architecture of a recording and reproducing apparatus according an embodiment of the present invention;

FIG. 3 is a block diagram illustrating an optical pick-up, installed in the recording and reproducing apparatus, according to a first embodiment of the present invention;

FIG. 4 is a schematic sectional view illustrating a lens unit of the optical pick-up according to the first embodiment of the present invention together with a recording medium;

FIG. 5 is a schematic sectional view illustrating a first embodiment of a focus adjuster installed in the optical pick-up together with the recording medium;

FIG. 6 is a side sectional view schematically illustrating a second embodiment of the focus adjuster installed in the optical pick-up;

FIG. 7 is a schematic sectional view illustrating the second embodiment of the focus adjuster together with the recording medium;

FIG. 8 is a schematic view illustrating a photo-detecting unit to split and receive a light beam in the recording and reproducing apparatus according to the embodiment of the present invention;

FIG. 9 is a block diagram illustrating a second embodiment of the optical pick-up installed in the recording and reproducing apparatus according to the present invention;

FIG. 10 illustrates an aspect of an astigmatic optical signal;

FIG. 11 illustrates shapes of reflected light beams detected by the photo-detecting unit;

FIG. 12 is a graph illustrating correlation between variation of a position where the light beam is focused on the recording medium and a focus error signal;

FIG. 13 is a flowchart illustrating a recording medium type determining method according to a first embodiment of the present invention;

FIG. 14 is a schematic view illustrating a track error signal according to the variation of the position where the light beam is focused on the recording medium;

FIG. 15 is a flowchart illustrating a recording medium type determining method according to a second embodiment of the present invention; and

FIG. 16 is a flowchart illustrating a recording and reproducing method according to a preferred embodiment of the present invention.

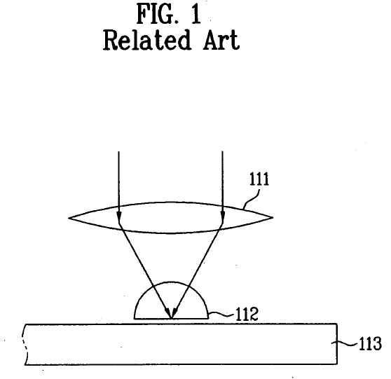

### DETAILED DESCRIPTION OF THE INVENTION

Hereinafter, preferred embodiments of an optical pick-up and a recording medium according to the present invention capable of implanting the above objects and features of the present invention will be described in detail with reference to the accompanying drawings. In the following description of the present invention, a “recording medium” indicates entire media to which data is already recorded or is able to record, such as an optical disc. Moreover, in the following description of the present invention, a “recording and reproducing apparatus” indicates entire apparatus enabling recording of data on the recording medium and reproduction of the recorded data from the recording medium. Although a recording and reproducing apparatus using a near field will be described for the illustrative convenience in the following description of the present invention, it is noted that the present invention is not limited to the embodiments.

In addition, wherever possible, terminologies used in the following description of the present invention are selected from general terminologies that are widely used at present. However, this applicant selects the terminologies voluntarily as required. In this case, since meanings of the voluntary terminologies will be described in the following description of the present invention in detail, it is noted that the present invention must not be understood by names of the terminologies, but by the meanings of the terminologies.

Hereinafter, embodiments of a recording and reproducing apparatus according to the present invention will be described in detail. Wherever possible, the same reference numbers will be used throughout the drawings to refer to the same or like parts.

### Embodiment 1

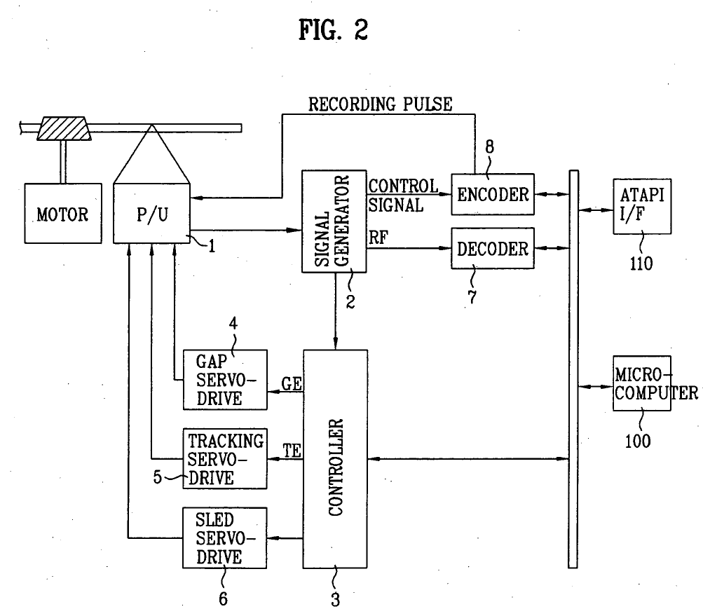

FIG. 2 schematically illustrates architecture of a recording and reproducing apparatus according a first embodiment of the present invention. The architecture of the recording and reproducing apparatus will be described in detail with reference to other drawings, as follows.

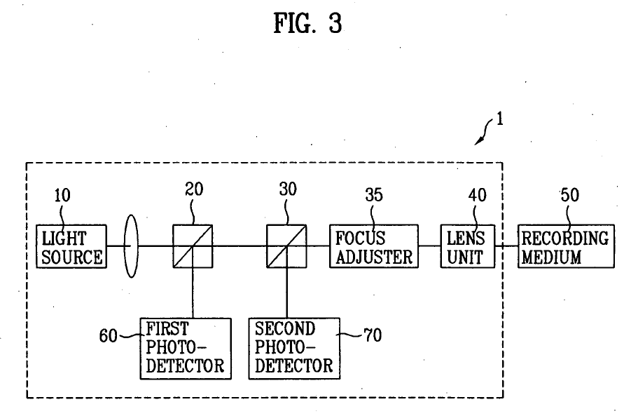

An optical pick-up 1 is a device to project a light beam on a recording medium and to focus the light beam reflected by the recording medium to generate a signal. An optical system (not shown) of the optical pick-up 1 may be configured as illustrated in FIG. 3. In more detail, the optical system provided in the optical pick-up 1 may include a light source 10, a splitting and combining unit 20 and 30, a focus adjuster 35, a lens unit 40, and an photo-detecting unit 60 and 70. The components of the optical pick-up 1 will be described in detail as follows.

The optical pick-up 1 is a device to project the light beam on the recording medium 50 and to generate a signal by focusing the light beam reflected by the recording medium 50. The components of the optical pick-up 1 will be described in detail as follows.

As the light source 10, a laser having an excellent directionality may be employed. Particularly, the light source 10 may employ a laser diode. A lens such as a collimating lens may be provided in a light path of the light beam emitted from the light source 10 to collimate the light beam to be projected on the recording medium.

The splitting and combining unit 20 and 30 is a device to split a light path of light beams entering in the same direction and to combine light paths of light beams entering in directions different from each other into one light path. In this embodiment of the present invention, since the splitting and combining unit includes a first splitting and combining unit 20 and a second splitting and combining unit 30, each of them will be described. The first splitting and combining unit 20 is a device to pass some of the incident light beam and to reflect the rest of the light beam. For example, the first splitting and combining unit 20 may employ a non-polarized beam splitter (NBS). The second splitting and combining unit 30 is a device to pass a light beam polarized in a specific direction according to a polarizing direction. For example, the second splitting and combining unit 30 may employ a polarized beam splitter (PBS). In other words, the second splitting and combining unit 30 may be configured to pass only a vertically polarized component of a linearly polarized light beam and to reflect a horizontally polarized component of the linearly polarized light beam. Conversely, the second splitting and combining unit 30 may be configured to pass the horizontally polarized component of the linearly polarized light beam and to reflect the vertically polarized component of the linearly polarized light beam.

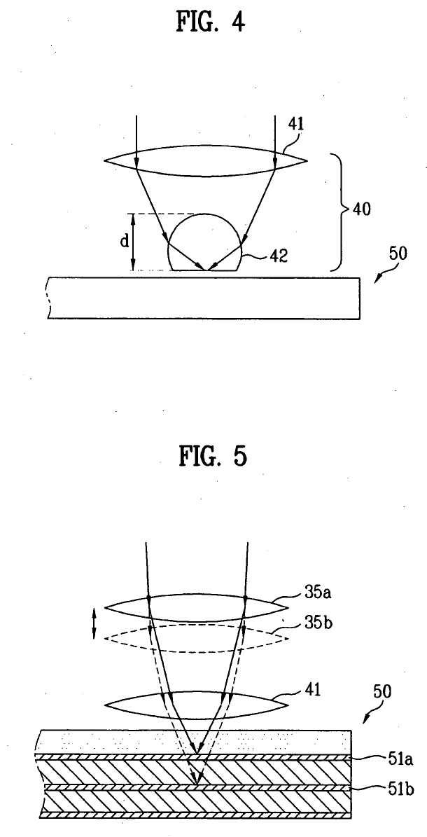

The lens unit 40 is a device to project the light beam emitted from the light source 10 to the recording medium 50. The lens unit 40, in this embodiment of the present invention, includes an objective lens 41 and a high-index lens 42 provided in a light path through which the light beam passing through the objective lens 41 enters the recording medium 50, as illustrated in FIG. 4. In other words, the objective lens 41 and the high-index lens 42 are provided therein to increase the numerical aperture of the lens unit 40 and due to this, to generate an evanescent wave. Here, for the illustrative convenience, the high-index lens 42 is referred to a ‘near field generating lens’. The near field generating lens 42 may employ a solid immersion lens (SIL), and a semi-spherical lens or a ultra-semi-spherical generated by cutting a spherical lens (a part of a sphere having a thickness between thicknesses of a sphere and a semi-sphere). In this case, a cut-off cross section of the near field generating lens 42 may be ground in a cone shape whose end has a predetermined area such that the light beam is concentrated to the end.

Moreover, the optical system of the optical pick-up including the lens unit 40 is positioned very closely to the recording medium 50. A detailed description thereof will follow. When the lens unit 40 approaches the recording medium 50 to less than about ¼ of the wavelength of the light beam (that is, λ/4), the evanescent wave generated in the lens unit 40 can be used to record and reproduce data while maintaining the property thereof. However, when the distance between the lens unit 40 and the recording medium 50 is equal to or greater than λ/4, the wavelength of the light beam loses the property of the evanescent wave and returns to an original wavelength. Thus, in a conventional recording and reproducing apparatus using the near field, the lens unit 40 ensures the distance from the recording medium 50 is prevented from being greater than about λ/4. Here, λ/4 becomes a limit of the near field.

The focus adjuster 35 is a device to vary a focusing position of the light beam being projected on the recording medium 50. As described above, the recording and reproducing apparatus using the near field must maintain the distance between the lens unit 40 and the recording medium 50 when the lens unit 40 approaches the recording medium 50 closely for the use of the evanescent wave. Thus, since it is difficult to move the lens unit 40 directly in an axial direction, the focus adjuster 35 may be provided independently from the lens unit 40. The focus adjuster 35 may be configured to include at least one movable lens that is provided on an optical axis to vary the focusing position by changing a traveling path of the light beam.

A first embodiment of the focus adjuster 35 will be described with reference to FIG. 5.

The focus adjuster 35 includes a single lens moving along the optical axis. Due to the movement of the focus adjuster 35 (for example, moving from a position 35a to a position 35b), a position of the recording medium 50 on which the light beam is projected can be shifted from a first recording layer 51a to a second recording layer 51b. In other words, when the focus adjuster 35 is positioned at the first position 35a (indicated by a solid line), the light beam to be projected on the recording medium 50 by the objective lens 41 is focused on the first recording layer 51a of the recording medium 50. On the other hand, when the focus adjuster 35 is positioned at the second position 35b (indicated by a dotted line), the light beam to be projected on the recording medium 50 is focused on the second recording layer 51b of the recording medium 50. By doing so, it is possible to vary the focusing position of the light beam to be focused on the recording medium 50 by adjusting the focus adjuster 35 without moving the objective lens 41.

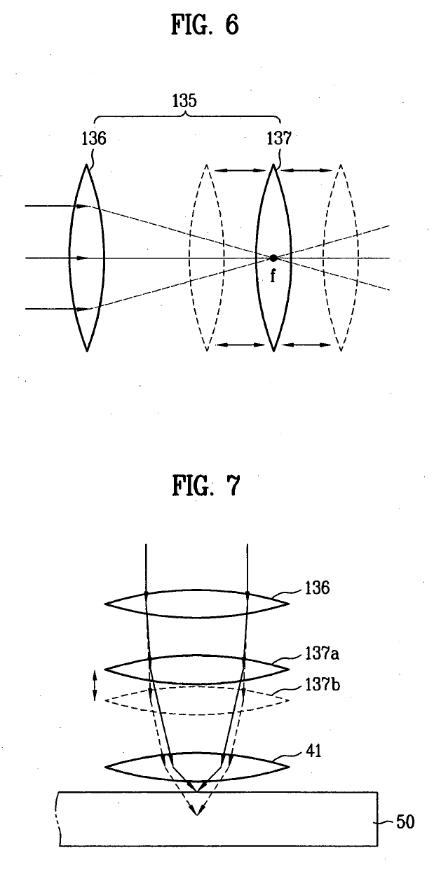

A second embodiment of a focus adjuster 135 will be described with reference to FIGS. 6 and 7.

The focus adjuster 135 may include two lenses. In this case, the focus adjuster 135 may be configured by a first fixed lens 136 and a second movable lens 137 as described in FIG. 6. In more detail, the second lens 137 is positioned at a focal point f to which the light beam passing through the first lens 136 is focused or moved inwardly or outwardly along the optical axis. The light beam, passing through the first lens 136, forms a divergent light beam, a convergent light beam, or a collimated light beam according to the position of the second lens 137. Thus, according to the position of the second lens 137, the light beam passing through the first lens 136 changes the light path of the light beam to be focused to the focal point f by diverging the light beam from the light path or by further focusing the same.

For example, as illustrated in FIG. 7, when the second lens 137 is positioned at the first position 137a (indicated by a solid line), the light beam to be projected on the recording medium 50 by the objective lens 41 is focused on the surface of the recording medium 50. On the other hand, when the second lens 137 is positioned at the second position 137b (indicated by a dotted line), the light beam to be projected on the recording medium 50 is focused on the inside of the recording medium 50. By doing so, it is possible to vary the focusing position of the light beam to be focused on the recording medium 50 by adjusting the focus adjuster 135 without moving the lens unit 40.

Here, the second movable lens 137 may have a thickness less than that of the first lens 136 in order to adjust the light path minutely. Moreover, the lenses of the focus adjuster 35 may be a combination of concave lenses and convex lenses, to vary the focal point of the light beam to be projected through the lens unit 40, and is not limited to the embodiments of the present invention.

In other words, rather than varying the position of the lens unit 40 using the focus adjuster 35, as described above, the focal point on the recording medium 50 can be varied. For this reason, even in the near field, a recording medium 50 having a plurality of recording layers can be used.

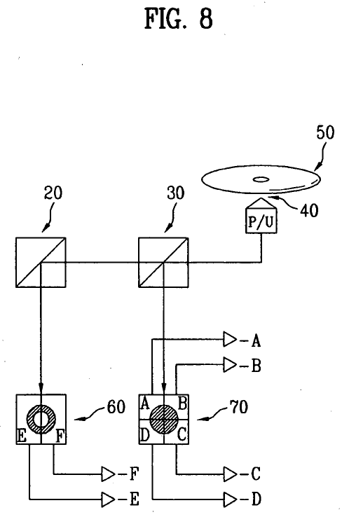

The photo-detecting unit 60 and 70 is a device to receive the reflected light beam to generate an electric signal corresponding to a quantity of the reflected light beam by performing photoelectric conversion. In this embodiment, the photo-detecting unit includes a first photo-detector 60 and a second photo-detector 70. Each of the first and second photo-detectors 60 and 70 may have specific regions in a signal tracking direction or in a radial direction of the recording medium 50, for example, two divided photo-diodes PDA and PDB. Here, the respective photo-diodes PDA and PDB generate electric signals A and B in proportion to the quantity of the received light beam. Otherwise, each of the photo-detectors 60 and 70 may include four photo-diodes PDA, PDB, PDC, and PDD respectively divided into two parts in the signal tracking direction and in the radial direction. FIG. 8 illustrates an example of the first photo-detector 60 having two photo-diodes E and F and an example of the second photo-detector 70 having four photo-diodes A, B, C, and D. In this case, configurations of the photo-diodes of the respective photo-detectors 60 and 70 are not limited to this embodiment, but can be modified in various forms as needed.

A signal generator 2 in FIG. 2 generates a radio frequency signal (RF) necessary to reproduce data using a signal generated from the optical pick-up 1, and a gap error signal (GE) and a track error signal (TE) that are necessary for a servo-control. For example, as illustrated in FIG. 8, the gap error signal GE can be obtained by combining (E+F) the electric signals E and F generated by the first photo-detector 60. In this case, since the gap error signal GE is proportional to the distance between the lens unit 40 and the recording medium 50, the gap error signal GE can be utilized to control the distance. Moreover, the RF signal RF can be obtained by combining (A+B+C+D) electric signals A, B, C, and D generated from the second photo-detector 70, and another control signal can be generated in the same way.

In addition, the signal generator 2 may be configured to generate a signal with compensated offset by compensating offset that would be contained in the generated signal. For example, the signal generator 2 may be configured to compensate an optical offset, contained in the track error signal TE, due to the movement of the lens and an offset due to a difference of the quantity of the reflected light beam. However, it is noted that the offset compensation can be carried out by the controller 3 or other devices in addition to the signal generator 2. The process of generating the signals using the signal generator 2 will be described later with reference to the drawings.

The controller 3 receives the signals generated by the photo-detectors 60 and 70 or the signal generator 2, and determines a type of the recording medium 50 using the received signals. For example, the controller 3 can set a position where the light beam is focused when a value of the focus error signal FE is 0 (zero) as a position on the recording layer, or a position where the light beam is focused when a value of the RF signal RF or the tracking error signal TE is maximal as the position on the recording layer. Otherwise, a position, when the value of the focus error signal FE is 0 (zero) and the value of the RF signal RF or the tracking error signal TE is maximal, can be set to as the position on the recording layer. In other words, in corresponding to a periodic property of the signals being varied with time, the controller 3 can determine or generate the number, a thickness, or positional information of the recording layer of the recording medium. A type of the recording medium can be determined according to the information. For example, the controller 3 may be configured to determine the type of the recording medium according to how far is a distance between the position of the recording layer and the upper surface of the recording medium to which the light beam is projected by the optical pick-up.

In addition, the controller 3 generates the control signal or a driving signal in response to the received signal. For example, the controller 3 performs a signal processing of the gap error signal GE and outputs a driving signal for the control of the distance between the lens unit 40 and the recording medium 50 to a gap servo-drive 4. Otherwise, the controller 3 performs a signal processing of the tracking error signal TE and outputs a driving signal for a tracking control to a tracking servo-drive 5.

The gap servo-drive 4 moves the optical pick-up 1 or the lens unit 40 of the optical pick-up 1 upward and downward by driving an actuator (not shown) in the optical pick-up 1. By doing so, the distance between the lens unit 40 and the recording medium 50 can be maintained constant. The gap servo-drive 4 may play a role of a focus servo. For example, the gap servo-drive 4 may make the optical pick-up 1 or the lens unit 40 of the optical pick-up 1 track the upward and downward movement of the recording medium 50 during rotation of the recording medium 50 according to a signal for the focus control of the controller 3.

The tracking servo-drive 5 moves the optical pick-up 1 or the lens unit 40 of the optical pick-up 1 in the radial direction to modify a position of the light beam by driving a tracking actuator (not shown) in the optical pick-up 1. Due to this, the optical pick-up 1 or the lens unit 40 of the optical pick-up 1 can track a desired track formed in the recording medium 50. The tracking servo-drive 5 can move the optical pick-up 1 or the lens unit 40 of the optical pick-up 1 in the radial direction in response to a track shifting command.

A sled servo-drive 6 can move the optical pick-up 1 in the radial direction in response to the track shifting command by driving a sled motor (not shown) provided to move the optical pick-up 1.

The above-described recording and reproducing apparatus may be connected to a host such as personal computer (PC). The host transmits recording/reproducing commands to a microcomputer 100, receives data reproduced from a decoder 7, and transmits data to be recorded to an encoder 8, via an interface. The microcomputer 100 controls the decoder 7, the encoder 8, and the controller 3 according to the recording/reproducing commands from the host.

In this case, the interface, generally, may employ an advanced technology attached packet interface (ATAPI) 110. The ATAPI 110 is an interface standard between an optical recording and reproducing apparatus such as a CD drive, a DVD drive, and the like, proposed to transmit decoded data from the optical recording and reproducing apparatus to the host, and converts the decoded data into a packet type protocol which can be processed by the host so as to transmit the converted data to the host.

Hereinafter, the operational sequence of the recording and reproducing apparatus according to the first embodiment of the present invention will be described in detail in the order of advancing direction of the light beam emitted from the light source 10 within the optical system and according to flow of a signal in other places.

The light beam emitted from the light source 10 of the optical pick-up 1 enters the first splitting and combining unit 20 such that some of the incident light beam passes therethrough and the rest enters the second splitting and combining unit 30. The second splitting and combining unit 30 passes the vertically polarized component of the linearly polarized light beam and reflects the horizontally polarized component thereof (may be operated vice versa). In the light path through which the light beam passes the second splitting and combining unit 30, a polarizing conversion plane (not shown) may be further provided, and will be described later.

The light beam passing through the second splitting and combining unit 30 passes through the focus adjuster 35 and enters the lens unit 40 due to changed light path. At that time, the light beam entering the objective lens of the lens unit 40 generates the evanescent wave while passing through the near field generating lens. In more detail, the light beam entering the near field generating lens at an angle equal to or greater than a critical angle is totally reflected by the surface of the lens and the surface of the recording medium 50. The light beam entering the near field generating lens at an angle equal to or less than the critical angle is reflected by the recording layer of the recording medium 50. The evanescent wave generated during this process arrives at the recording layer of the recording medium 50 to perform the recording and reproducing of data.

The light beam reflected by the recording medium 50 enters the second splitting and combining unit 30 via the lens unit 40 and the focus adjuster 35 again. In this case, the polarizing conversion plane (not shown) may be provided in the light path through which the light beam enters the second splitting and combining unit 30. The polarizing conversion plane converts the polarized directions of the light beam entering the recording medium 50 and the reflected light beam. For example, a quarter wave plate (QWP) is used as the polarizing conversion plane to perform the left-hand circular polarization of the light beam entering the recording medium 50 and the right-hand circular polarization of the reversely entering light beam. Consequentially, the polarized direction of the reflected light beam passing through the QWP is converted into the direction reverse to that of the incident light beam, and an angle difference therebetween becomes 90 degrees. Thus, the incident light beam in which the horizontally polarized component passes through the second splitting and combining unit 30 is reflected by the recording medium 50 and has only the vertically polarized component when entering the second splitting and combining unit 20 again. Consequently, the reflected light beam with the vertically polarized component is reflected by the second splitting and combining unit 30 and the reflected light beam enters the second photo-detector 70.

Since the numeric aperture of the lens unit 40 of the near field recording and reproducing apparatus is greater than 1 (one), distortion occurs in the polarizing direction during the projection and reflection through the lens unit 40. In other words, some of the reflected light beam entering the second splitting and combining unit 30 has the horizontally polarized component due to the distortion in the polarizing direction and the rest thereof passes through the second splitting and combining unit 30. The passing reflected light beam enters the first splitting and combining unit 20. The first splitting and combining unit 20 passes some of the incident light beam and reflects the rest thereof. The light beam reflected by the first splitting and combining unit 20 enters the first photo-detector 60.

The first and second photo-detectors 60 and 70 output electric signals corresponding to the quantity of the received reflected light beam. The signal generator 2 generates the gap error signal GE, the track error signal TE, or the RF signal RF using the electric signals outputted from the photo-detectors 60 and 70. For example, when the first photo-detector 60 includes two photo-diodes, the two photo-diodes of the first photo-detector 60 respectively output electric signals E and F corresponding to the respective quantities of the received light beams. When the second photo-detector 70 includes four photo-diodes, the four photo-diodes of the second photo-detector 70 respectively output electric signals A, B, C, and D corresponding to the quantities of the received light beams. The signal generator 2 may generate the gap error signal GE for the control of the distance between the lens unit 40 and the recording medium 50 using the signals E and F outputted from the first photo-detector 60. In other words, the gap error signal GE may be generated by summing all the signals outputted from the photo-diodes of the first photo-detector 60. Since the gap error signal GE is proportional to the distance between the lens unit 40 and the recording medium 50, the gap error signal GE may be used to control the distance. Moreover, the signal generator 2 may generate the RF signal RF, the track error signal TE, or the like using the signals generated from the second photo-detector 70.

The controller 3 performs feedback control using the gap error signal GE such that the distance between the lens unit 40 and the recording medium 50 can be maintained constant. Thus, the lens unit 40 moves upward and downward with the upward and downward movement of the recording medium 50 to track the recording medium 50. By doing so, the light beam focused on the recording medium 40 by the lens unit 40 is controlled and deviate from the recording layer.

The controller 3 may control the focus adjuster 35 if there is an external shifting command of the recording layer (shifting command to shift from the first recording layer to the second recording layer), or if necessary to shift to the other recording layer. In other words, the controller 3 may adjust the focus adjuster 35 to change the recording layer on which the light beam is focused on the recording medium 50, and may scan the recording medium 50 using the light beam.

### Embodiment 2

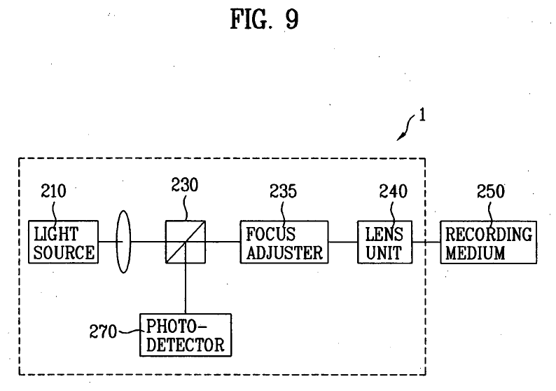

Hereinafter, for the illustrative convenience, the description of the same components as the first embodiment will be omitted and different components will be described in detail. FIG. 9 illustrates configuration of an optical pick-up 1 provided in a recording and reproducing apparatus according to the second embodiment of the present invention. As illustrated, in this embodiment, the optical pick-up 1 may include a single splitting and combining unit 230 and a single photo-detector 270. In more detail, even in a case of a recording and reproducing apparatus not using a gap error signal GE, the above-described focus adjuster 235 is provided so that there is an advantage of converting the light path as in the first embodiment.

Hereinafter, a method of determining a type of the recording medium and a recording and reproducing method in the recording and reproducing apparatus including the focus adjuster 235 will be described in detail with reference to the drawings.

A first embodiment of the method of determining a type of the recording medium is as follows.

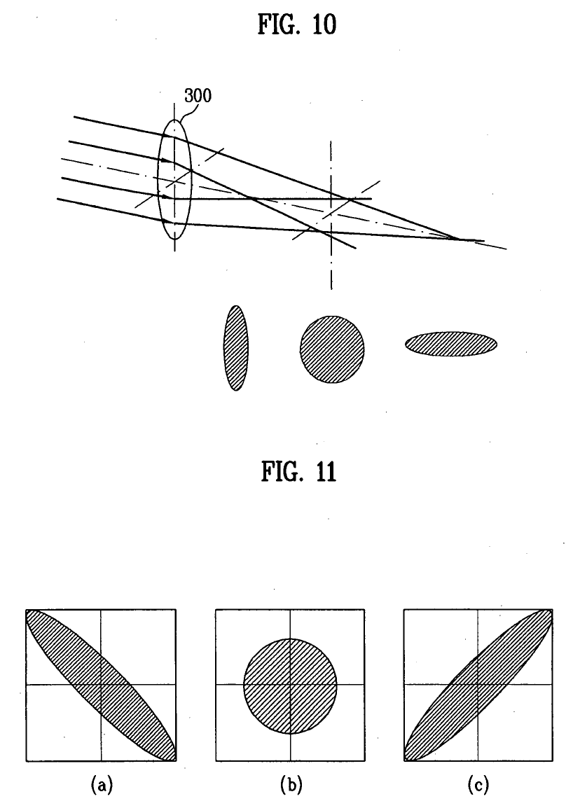

The type of the recording medium 50 can be determined using a focus error signal FE obtained during the focus scanning of the recording medium 50, and will be described in detail with reference to FIGS. 10 to 13.

The focus error signal GE is a signal indicating the symmetric properties of reflected light beams received by the second photo-detector 70 in FIG. 3 or a photo-detector 170 in FIG. 9, and may be processed in the astigmatic way. In a case of using the astigmatic way, the recording and reproducing apparatus may further include the second photo-detector 70 in FIG. 3 or an astigmatic lens (not shown) provided in a light path facing the photo-detector 170 in FIG. 9. In this description, for illustrative convenience, a case of employing the second photo-detector 70 will be described.

FIG. 10 illustrates characteristics of an astigmatic optical signal. Here, as an astigmatic lens, a cylindrical lens 300 may be employed. The cylindrical lens 300 has a property that a focal distance in a certain direction is different from a focal distance in another direction perpendicular to the direction, and this property is known as astigmatism. In other words, two focal points are generated by light beams traveling in different directions. Here, between the two focal points, there is a point where a divergent light beam and a convergent light beam have an identical sized diameter, and a cross-section of the distributed light beam at this point becomes a circular shape. At one of two focal points, near to the cylindrical lens 300, an oval light beam having a major oval axis in the vertical direction is formed, and at the other farther therefrom, an oval light beam having a major oval axis in the horizontal direction is formed. Thus, when the second photo-detector 70 is positioned at the point where the light beam having the circular cross-section, the positional variation of the light beam being focused according to the variation of the light distribution can be acquired. In other words, according to whether the focus of the light beam passing through the cylindrical lens 300 is accurately positioned on the recording layer or not, the signals depicted in FIG. 11 are formed. In other words, the light beam has a cross-section in the form as illustrated in FIG. 11a when a position on which the light beam is focused through the lens unit 40 is farther than the recording layer, a cross-section in the form as illustrated in FIG. 11c when the position is near the recording layer, and a cross-section in the form as illustrated in FIG. 11b when the position is positioned on the recording layer.

The focus error signal FE may be generated by the following formula, where C and D are signals generated by the second photo-detector 70 in FIG. 3 and k1 is a proportional constant to be experimentally determined.

FE=k1[(A+C)−(B+D)]

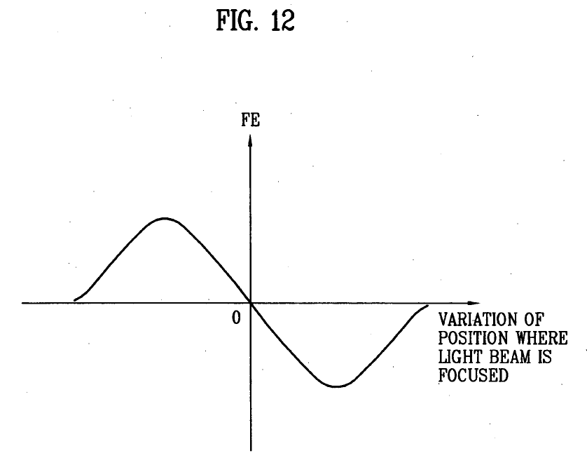

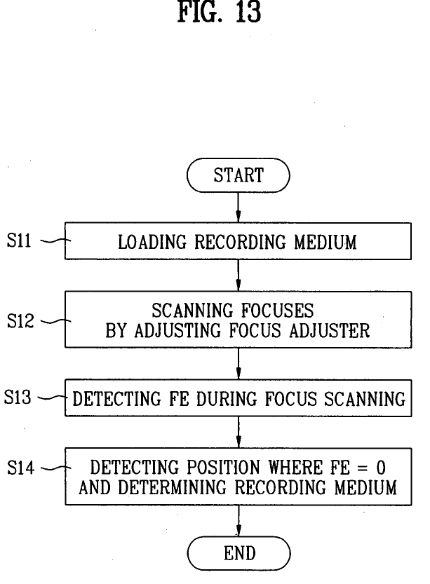

In a case of performing the focus scanning the position where the light beam is focused from the farther position to the near position, the focus error signal FE forms an S-shaped curve as illustrated in FIG. 12. In this case, a position on the recording medium 50 where the light beam is focused when FE=0 (zero) corresponds to the recording layer. Thus, from the focus error signal FE detected during the focus scanning, a position of FE=0 (zero) is detected so that information about the recording medium 50 can be obtained.

An example thereof will be described as follows. If counting the position where the focus error signal FE, detected during the focus scanning of the recording medium 50, is 0 (zero), that is, FE=0 (zero), a single layer recording medium and a multi-layer recording medium can be distinguished from each other. Moreover, the number of recording layers of the multi-layer recording medium 50 can be counted.

It is possible to obtain a thickness of a cover layer, in which the points where FE=0 during the focus scanning are provided on the upper side of the recording layer at an initial time, to protect the recording layers and obtain information about a position of the recording layer. When a spacer layer is provided to space out the recording layers, an interval where FE=0 is repeated is measured so that a thickness of the spacer layer can be measured. In the above way, the number, the thickness, and/or information about a position of the recording layer can be obtained. Based on this, architecture of the recording medium 50 can be determined. Moreover, based on the information about the position of the recording layer, a type of the recording medium 50 can be also determined.

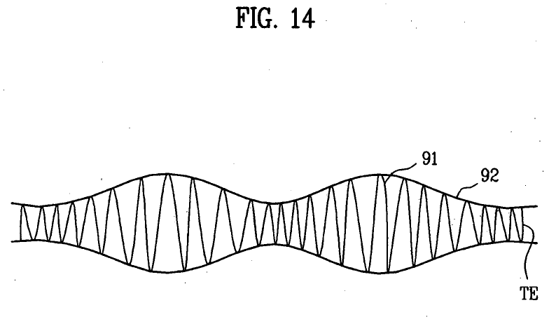

The above-described recording medium determining method will be sequentially described with reference to FIG. 13.

The recording medium 50 is loaded into the recording and reproducing apparatus (S11). Then, the recording and reproducing apparatus adjusts the focus adjuster 35 before reading information recorded in the recording medium 50 and performs the focus scanning (S12). In other words, the controller 3 moves the movable lens of the focus adjuster 35 in the optical axis to scan the light beam projected on the recording medium 50.

The controller 3 detects the focus error signal FE generated during the focus scanning and the position where FE=0 (S13). Based on the detection, the controller 3 reads information about the number, the thickness, and the position of the recording layer so that it can be determined whether the recording medium corresponds to a recording medium that the user wants or compatible with the recording and reproducing apparatus (S14).

A second embodiment of the recording medium determining method will be described as follows.

The recording medium 50 can be determined using the tracking error signal TE or the RF signal RF, obtained during the focus scanning of the recording medium 50. Since ways of using the tracking error signal TE and the RF signal RF are identical to each other, a case of using the tracking error signal TE will be described in detail as an example of using the identical way, and it is noted that a case of using an identical principle can be applied to other embodiments as well as this embodiment.

The tracking error signal TE is a signal indicating asymmetry of the reflected light beam by which the light beam deviates form the track of the recording medium 50. Tracks of the rotating recording medium 50 are vibrated due to several reasons. The track vibration has a rotational frequency component and several high frequency components of the recording medium 50. Even when there is an external disturbance such as vibration, temperature change, and the like, it is possible that the position, on which the light beam is projected, tracks the track vibration to record and/or reproduce data to and/or from the tracks. When the actuator is driven in a deflecting direction, that is, in the direction reverse to a direction of deviating from the track, the optical pick-up can always track the track. When the optical pick-up deviates from a track due to the deflection of the recording medium, since a single sine wave is outputted with respect to the tracking error TE, the quantity of the deflection of the loaded recording medium is measured by counting the number of the sine waves outputted for one revolution of the recording medium and the tracking error signal TE is expressed in the form of the sine wave.

Here, the tracking error signal can be generated as the following formula, where A+B+C+D indicates a signal generated by the second photo-detector 70 in FIG. 3 and k2 corresponds to a proportional constant to be experimentally determined.

TE=k2[(A+D)−(B+C)]

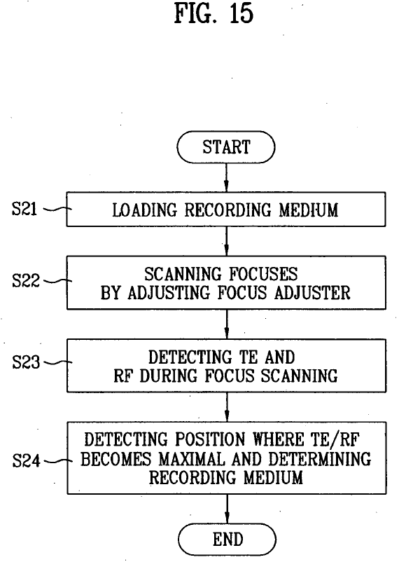

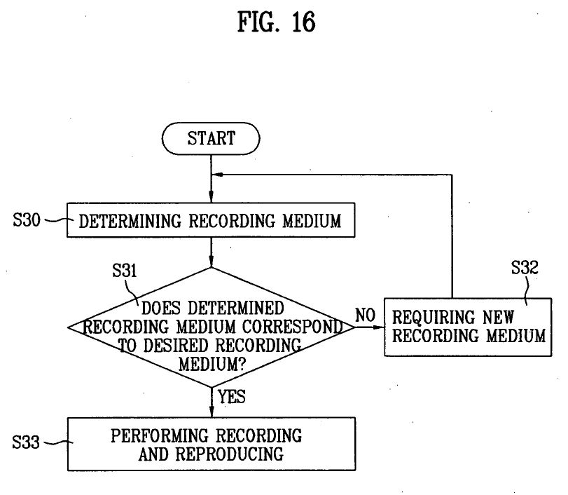

The tracking error signal TE expressed by the above formula forms a sine wave periodically varied as illustrated in FIG. 14 when the position on which the light beam is focused is scanned from a position farther than the recording layer to a position near to the recording layer. The periodic variation is generated because the quantity of the reflected light beam is maximal when the light beam to be projected on the recording medium 50 is focused on the surface of the recording layer and otherwise is decreased. Thus, since a quantity difference of the reflected light beam is generated according to the variation of the position where the light beam is focused on the recording medium 50, the periodically varying sine wave is formed.

In other words, when the light beam is focused on the surface of the recording layer, the quantity of the reflected light beam has a maximum value 91 and is gradually decreased as the position is changed. When the light beam is projected on the surface of a next recording layer, the quantity of the reflected light beam has a maximum value again. Thus, from an envelope 92 depicted by connecting peak points of the sine wave, the variation of the periodic signal is obtained and the recording medium 50 can be determined.

An example will be described as follows. When counting points where the tracking error signals TE detected during the focus scanning of the recording medium 50 are the maximum values, the single layer recording medium and the multi-layer recording medium can be distinguished from each other. Moreover, the number of the recording layers of the multi-layer recording medium can be counted.

It is possible to obtain a thickness of a cover layer, provided on the upper side of the recording layer, to protect the recording layers and obtain information about a position of the recording layer, by setting the point where TE is maximal during the focus scanning to an initial time. When a spacer layer is provided to space out the recording layer, an interval, where TE is maximal is repeated, is measured so that a thickness of the spacer layer can be measured. In the above way, the number, the thickness, and/or information about a position of the recording layer can be obtained. Based on this, structure of the recording medium 50 can be determined.

The above-described recording medium determining method will be sequentially described with reference to FIG. 15.

The recording medium 50 is loaded into the recording and reproducing apparatus (S22). Then, the recording and reproducing apparatus adjusts the focus adjuster 35 before reading information recorded in the recording medium 50 and performs the focus scanning (S22). In other words, the controller 3 moves the movable lens of the focus adjuster 35 in the optical axis to scan the light beam projected on the recording medium 50.

The controller 3 detects the position where the tracking error signal TE is maximal from the envelope 92 of the tracking error signal TE generated during the focus scanning (S23). Based on the detection, the controller 3 reads information about the number, the thickness, and the position of the recording layer so that it can be determined whether the recording medium corresponds to a recording medium that the user wants or compatible with the recording and reproducing apparatus (S24).

A third embodiment of the recording medium determining method will be described as follows.

The recording medium 50 can be determined using the focus error signal FE together with the tracking error signal TE or the RF signal RF, obtained during the focus scanning of the recording medium 50. Since, in the way of using the focus error signal FE as described in the first embodiment, the light beam to be projected on the recording medium 50 may contain an offset when the light beam deviates from the track due to the deflection of the recording medium. Thus, during the determination using the focus error signal FE, whether the offset is contained or not is determined by checking the tracking error signal TE only or together with the RF signal RF. For example, in this embodiment, a process of checking whether the tracking error signal TE or the RF signal RF has the maximum value or not at the position where FE=0, detected using the focus error signal FE, may be further included.

The above-described recording medium determining method will be sequentially described as follows.

When the recording medium 50 is loaded, the recording and reproducing apparatus previously performs the process of reading data to determine the recording medium 50 in the above-described way (S30). In other words, based on the signals generated by the focus scanning, information about the recording medium 50 is obtained. Then, the recording and reproducing apparatus determines whether the loaded recording medium 50 corresponds to a desired recording medium that the user wants or compatible with the recording and reproducing apparatus (S31). If not, the recording and reproducing apparatus may require insertion of a new recording medium (S32). When a recording medium 50 corresponding to the desired recording medium is loaded, the recording and reproducing apparatus performs a process of reading data containing managing information stored in the recording medium 50 or recording data on the recording medium 50 (S33). By doing so, time necessary to read the managing information stored in the recording medium 50 is reduced and the recording medium 50 is determined so that data can be recorded or reproduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An optical pick-up comprising:
a lens unit to focus or project a light beam emitted from a light source;
a focus adjuster, provided in a path of the light beam, to vary a position where the light beam is projected on a recording medium and to scan the recording medium; and
an photo-detecting unit to receive the light beam reflected by the recording medium and to generate a signal.

2. The optical pick-up according to claim 1, wherein the focus adjuster comprises at least one adjustable lens to vary the path of the light beam.

3. The optical pick-up according to claim 2, wherein the focus adjuster further comprises:
a first lens having a fixed position; and
a second lens moving in the optical axis.

4. A recording and reproducing apparatus comprising:
a lens unit to focus or project a light beam emitted from a light source;
a focus adjuster, provided in a path of the light beam, to vary a position where the light beam is projected on a recording medium and to scan the recording medium;
an photo-detecting unit to receive the light beam reflected by the recording medium and to generate a signal; and
a controller to determine the recording medium using the signal generated during the scanning.

5. The recording and reproducing apparatus according to claim 4, wherein the focus adjuster comprises at least one adjustable lens to vary the path of the light beam.

6. The recording and reproducing apparatus according to claim 5, wherein the focus adjuster further comprises:
a first lens having a fixed position; and
a second lens moving in the optical axis.

7. The recording and reproducing apparatus according to claim 4, wherein the controller generates information about a number, a thickness, or a position of recording layers of the recording medium in response to a period of the varying signal.

8. The recording and reproducing apparatus according to claim 4, wherein the controller determines a position where the light beam is focused when a value of a focus error signal becomes 0 (zero), as a position of a recording layer.

9. The recording and reproducing apparatus according to claim 8, wherein the focus error signal comprises a signal indicating symmetry of the reflected light beam formed in the astigmatic way.

10. The recording and reproducing apparatus according to claim 4, wherein the controller determines a position where the light beam is focused when a value of a radio frequency signal or a tracking error signal is maximal, as a position of a recording layer.

11. The recording and reproducing apparatus according to claim 4, wherein the controller determines a position where a value of a focus error signal becomes 0 (zero) and a value of a radio frequency signal or a tracking error signal becomes maximal, as a position of a recording layer.

12. A recording and reproducing apparatus comprising:
a lens unit including an objective lens and a high-index lens having a refractive index higher than that of the objective lens;
a focus adjuster, provided in a path of a light beam emitted from a light source and projected on a recording medium, to vary a position where the light beam is projected on the recording medium and to scan the recording medium;
first and second photo-detectors to respectively receive light beams reflected by the recording medium and split by a splitting and combining unit; and
a controller to determine the recording medium using a signal generated during the scanning.

13. The recording and reproducing apparatus according to claim 12, wherein the focus adjuster comprises at least one adjustable lens to vary the path of the light beam.

14. The recording and reproducing apparatus according to claim 13, wherein the focus adjuster further comprises:
a first lens having a fixed position; and
a second lens moving in the optical axis.

15. The recording and reproducing apparatus according to claim 12, wherein on of the photo-detector generates a gap error signal and the other photo-detector generates a focus error signal, a tracking error signal, or a radio frequency signal.

16. The recording and reproducing apparatus according to claim 12, wherein the controller determines a position where the light beam is focused when a value of a focus error signal becomes 0 (zero), as a position of a recording layer.

17. The recording and reproducing apparatus according to claim 15, wherein the controller determines a position where the light beam is focused when a value of a radio frequency signal or a tracking error signal is maximal, as a position of a recording layer.

18. The recording and reproducing apparatus according to claim 15, wherein the controller determines a position where a value of a focus error signal becomes 0 (zero) and a value of a radio frequency signal or a tracking error signal becomes maximal, as a position of a recording layer.

19. A method of determining a recording medium in a recording and reproducing apparatus, the method comprising:
(a) minutely controlling a position of a light beam being focused on the recording medium;
(b) controlling the position of the light beam being projected on the recording medium in a scale greater than the step (a); and
(c) scanning focuses on the recording medium and determining the recording medium, using the controlling in the step (b).

20. The method of determining a recording medium in a recording and reproducing apparatus according to claim 19, wherein, in the step (a), a control of a distance between a lens unit of the recording and reproducing apparatus and the recording medium is carried out to prevent the light beam from deviating from a recording layer of the recording medium.

21. The method of determining a recording medium in a recording and reproducing apparatus according to claim 19, wherein, in the step (b), a position where the light beam is focused on the recording medium is varied by adjusting a focus adjuster.

22. The method of determining a recording medium in a recording and reproducing apparatus according to claim 19, wherein, in the step (c), a number, a thickness, or a position of a recording layer of the recording medium is determined in response to a periodic property of a varying signal detected during the scanning of the focuses.

23. The method of determining a recording medium in a recording and reproducing apparatus according to claim 19, wherein, in the step (c), a type of the recording medium is determined in response to a periodic property of a varying signal detected during the scanning of the focuses.

24. The method of determining a recording medium in a recording and reproducing apparatus according to claim 22, wherein, in the determining, the number of times when a value of a focus error signal becomes 0 (zero) is counted.

25. The method of determining a recording medium in a recording and reproducing apparatus according to claim 22, wherein, in the determining, the number of times when a value of a radio error signal or a tracking error signal becomes maximal is counted.

26. A recording medium determining method of a recording and reproducing apparatus comprising a lens unit and a focus adjuster, provided in a path of a light beam entering the lens unit, to vary a position where the light beam is focused on a recording medium, the method comprising:
adjusting the focus adjuster when the recording medium is inserted into the recording and reproducing apparatus; and
determining the recording medium by scanning the recording medium.

27. The recording medium determining method of a recording and reproducing apparatus according to claim 26, wherein, in the determining, the number, a thickness, or a position of a recording layer of the recording medium is determined in response to a periodic property of a varying signal detected during the scanning of focuses on the recording medium.

28. The recording medium determining method of a recording and reproducing apparatus according to claim 26, wherein, in the determining, a type of the recording medium is determined in response to a periodic property of a varying signal detected during the scanning of focuses on the recording medium.

29. The recording medium determining method of a recording and reproducing apparatus according to claim 27, wherein, in the determining, the number of times when a value of a focus error signal becomes 0 (zero) is counted.

30. The recording medium determining method of a recording and reproducing apparatus according to claim 27, wherein, in the determining, the number of times when a value of a radio error signal or a tracking error signal becomes maximal is counted.
